(19) United States
(12) Patent Application Publication
(10) Pub. No.: US 2023/0022271 A1
(43) Pub. Date: Jan. 26, 2023

(54) MEDIA SENSOR OF IMAGE FORMING DEVICE FOR COMPENSATING TRANSMITTED LIGHT AMOUNT BASED ON TEMPERATURE DATA

(71) Applicant: HEWLETT-PACKARD DEVELOPMENT COMPANY, L.P., Spring, TX (US)

(72) Inventors: Jung-Hyun SHIN, Seongnam-si (KR); Dong Woo KIM, Seongnam-si (KR); Jin Sik OH, Seongnam-si (KR)

(73) Assignee: HEWLETT-PACKARD DEVELOPMENT COMPANY, L.P., Spring, TX (US)

(21) Appl. No.: 17/791,037

(22) PCT Filed: Dec. 31, 2020
(86) PCT No.: PCT/US2020/067668

§ 371 Date: Jul. 6, 2022

(30) Foreign Application Priority Data
Jan. 10, 2020 (KR) 10-2020-0003539

(51) Int. Cl. G03G 15/00

(52) U.S. Cl. CPC G03G 15/5029; G03G 15/55; G03G 2215/00084

(57) ABSTRACT

An image forming device includes: a print engine to form an image on a medium, a sensor to irradiate light onto the medium and to detect an amount of light transmitted through the medium, and a processor to control the print engine based on the detected transmitted light amount and temperature data.

### BACKGROUND

An image forming device may refer to a device to print data generated by a print control terminal, such as a computer, on a print paper. The image forming device may include, for example, a copier, a printer, or a facsimile. The image forming device may also include a multi-function peripheral (MFP) to implement multiple functions, including functions of the copier, the printer and the facsimile, in a single device.

### BRIEF DESCRIPTION OF THE DRAWINGS

FIG. 1 is a block diagram showing an example of a brief configuration of an image forming device;

FIG. 2 is a block diagram showing an example of a configuration of the image forming device;

FIG. 3 is a diagram showing an example of a configuration of a print engine of FIG. 1;

FIG. 4 is a schematic configuration diagram for describing an example of an installation form of a paper detection sensor of FIG. 1;

FIG. 5 is a conceptual diagram showing an operation example of the paper detection sensor;

FIG. 6 is a diagram showing examples of detected values depending on various manufacturing environments and operating environments;

FIG. 7 is a graph showing examples of measured values depending on user temperature environments;

FIG. 8 is a diagram showing examples of distributions of detected voltages before and after temperature compensation; and

FIG. 9 is a flowchart showing a paper detection method according to an example.

### DETAILED DESCRIPTION

Hereinafter, various examples are described in detail with reference to the drawings. Examples described below may be modified into several different forms. To clearly describe features of examples, the description omits a detailed description for contents well-known to those skilled in the art to which the following examples belong.

Meanwhile, when a component is referred to as being “connected to” another component in the specification, it means that the component and another component are “directly connected to” each other or are “connected to” each other with the other component interposed therebetween. In addition, when a component is referred to as “including” another component, it means the inclusion of other components rather than the exclusion of other components, unless explicitly described to the contrary.

In the specification, an “image forming job” may refer to various jobs (e.g., printing, scanning, or faxing) related to an image, such as forming of the image, creating/storing/transmitting of an image file or the like, and a “job” may refer to the image forming job, and also include a series of processes required for performing the image forming job.

In addition, an “image forming device” may refer to a device printing print data generated by a terminal device such as a computer on a recording paper. The image forming device may include, for example, a copier, a printer, a facsimile or a multi-function peripheral (MFP) implementing multiple functions of the copier, the printer and the facsimile in a single device.

In addition, the “print data” may refer to data converted into a printable format by a printer. The “print data” may be, for example, data on a printer language such as postscript (PS) or printer control language (PCL), or may be a file itself such as portable document format (PDF), x-ray photoelectron spectroscopy (XPS), bitmap (BMP) or joint photographic experts group (JPG).

Moreover, the “print data” may also refer to data converted into a format fixable to a medium by an image forming apparatus.

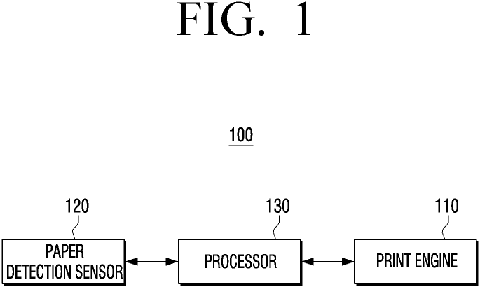

FIG. 1 is a block diagram showing an example of a brief configuration of an image forming device.

Referring to FIG. 1, an image forming device 100 may include a print engine 110, a sensor 120, for example a media sensor or a paper detection sensor, and a processor 130.

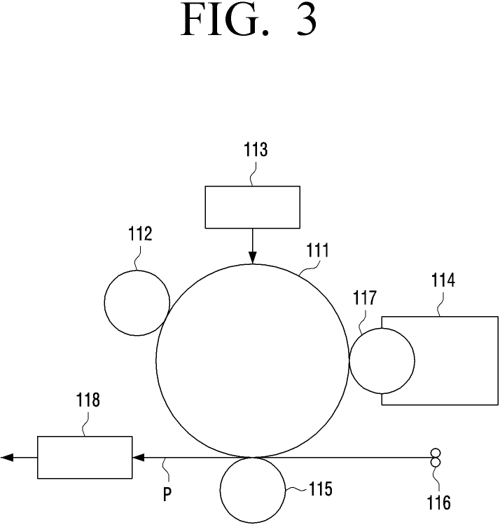

The print engine 110 may form an image on a medium, for example print paper. The print engine 110 may form an image using, for example, an inkjet method or an electrophotographic method. The below description describes an example configuration and operation of the print engine 110 using the electrophotographic method with reference to FIG. 3.

Here, the print paper may be referred to as a medium, recording medium, paper, label paper, coated paper, overhead projector (OHP) film, or the like.

The print engine 110 may perform the print job with a printing speed, a transfer condition and a fusing condition, which correspond to a thickness of the print paper determined by the processor 130 to be described below.

For example, in case of determining that a paper to be used is thicker than a plain paper, the print engine 110 may perform a transfer operation using a transfer voltage higher than a reference transfer voltage, or perform a fusing operation at a fusing temperature higher than a reference fusing temperature. In addition, the print engine may also perform an entire print job at a speed slower than a reference print speed.

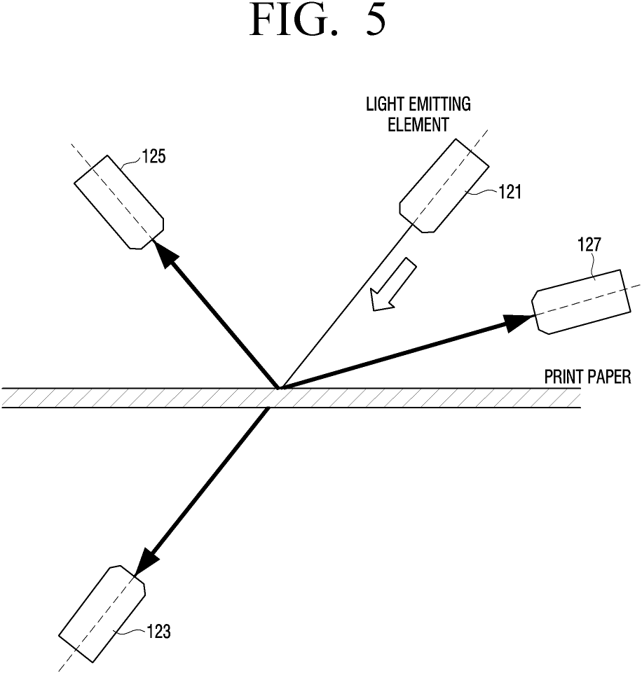

The paper detection sensor 120 may irradiate light onto the print paper and detect an amount of light transmitted through the print paper. The paper detection sensor 120 may be an optical media sensor and output an analog signal having voltage magnitude corresponding to the detected transmitted light amount. The below description describes configuration and operation of the paper detection sensor 120 with reference to FIG. 5.

The processor 130 may control an overall operation of the image forming device 100. In detail, the processor 130 may control the overall operation of the image forming device 100 by executing at least one instruction stored in a memory 150 to be described below. The processor 130 may be implemented as a central processing unit (CPU), an application specific integrated circuit (ASIC) or the like.

The processor 130 may determine whether there is a need for thickness detection of the print paper. For example, the processor may determine that the thickness detection of the print paper is needed in case that a tray, for example a paper tray, is opened or closed, or a new print job is received. Meanwhile, the processor 130 may be implemented to perform the thickness detection on every single print paper picked up for each print page.

If paper determination is necessary, the processor 130 may control the paper detection sensor 120 to irradiate light onto the print paper and to detect the transmitted light amount from the irradiated light. In case that the paper detection sensor 120 outputs a voltage value corresponding to the transmitted light amount, the processor 130 may determine magnitude of the voltage value output from the paper detection sensor 120 using an internal analog-to-digital converter (ADC) terminal. The voltage magnitude determined here may be data on the transmitted light amount.

The processor 130 may determine the thickness of the print paper using the detected transmitted light amount. Meanwhile, the paper detection sensor may show a distribution of a detected voltage depending on assembly tolerance of the sensor, thickness uniformity of the paper itself, and a temperature at the time of the detection. The media sensor may thus have a wider distribution in case of performing the detection at a temperature different from a temperature at the time of calibration.

To solve this problem, the processor may not use the detected transmitted light amount as it is, and compensate for the detected transmitted light amount using temperature data, and determine the thickness of the print paper using the compensated light amount.

For example, the processor 130 may calculate a compensation coefficient using a difference value between a reference temperature and an outside temperature of the image forming device; calculate a corrected transmitted light amount by applying the calculated compensation coefficient to the detected transmitted light amount; and determine the thickness of the print paper using the calculated corrected transmitted light amount.

Here, the reference temperature may refer to temperature data at the time of calculation of an initial calibration correction coefficient. The outside temperature may be a temperature value corresponding to the outside temperature of the image forming device 100. The outside temperature may refer to a temperature value directly measured by a temperature sensor, or may refer to estimated temperature data based on a current value flowing through a coil of a motor (for example, brushless direct current (BLDC) motor, direct current (DC) motor or the like) included in the print engine.

Meanwhile, the processor 130 may be implemented to receive and use temperature data on a space where the image forming device is installed through an external device.

In addition, the processor 130 may control the print engine 110 to perform the print job based on the determined thickness. For example, the processor 130 may perform the print job by adjusting the printing speed, a fusing state and a developing state based on the determined thickness of the print paper.

Meanwhile, the above description describes that the print job is performed by determining the thickness of the paper. However, the print job may also be performed by determining weight (gsm) of the paper in the above-described manner. In addition, the print job may also be performed by determining a type of the print paper by further considering the above-described thickness data and characteristics such as glossiness of the print paper.

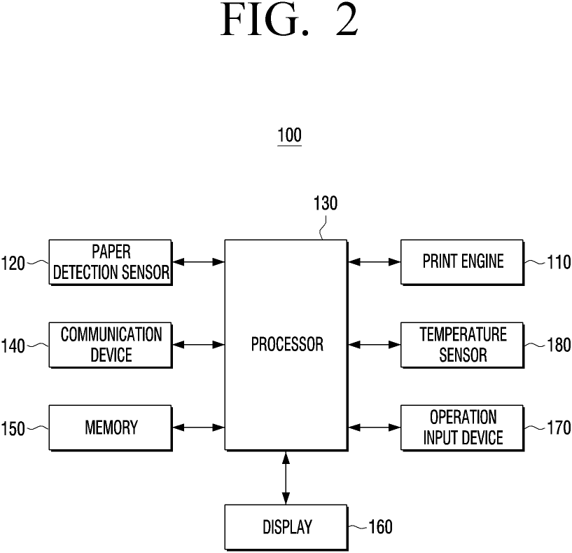

The above description shows and describes basic components included in the image forming device. However, the image forming device may be implemented to further include various components. These components are described below with reference to FIG. 2.

FIG. 2 is a block diagram showing an example of a configuration of the image forming device.

Referring to FIG. 2, the image forming device 100 according to an example of the disclosure may include the print engine 110, the paper detection sensor 120, the processor 130, a communication device 140, the memory 150, a display 160, an operation input device 170 and a temperature sensor 180.

The description omits redundant explanations of the print engine 110, the paper detection sensor 120 and the processor 130, which perform the same functions as described in FIG. 1.

The communication device 140 may be formed to connect the image forming device 100 to the external device, and this connection is possible through, for example, a local area network (LAN), the Internet, a universal serial bus (USB) port, and a wireless module. Here, the wireless module may be WiFi, WiFi Direct, near field communication (NFC), bluetooth or the like.

In addition, the communication device 140 may receive a job performance instruction from a host device. In addition, the communication device 140 may transmit and receive data related to the job performance instruction described above. For example, in case that a user’s job instruction is to print a particular file, the communication device 140 may receive its print data.

In addition, the communication device 140 may receive the temperature data on a space where the image forming device 100 is installed from the external device. In case of receiving the temperature data from the external device, the processor 130 may correct the transmitted light amount as described above using the received temperature data.

The memory 150 may store at least one instruction on the image forming device 100. In detail, the memory 150 may store various programs (or software) for operating the image forming device 100 according to various examples.

The memory 150 may store the print data received by the communication device 140. The memory 150 may be implemented as a storage medium in the image forming device 100 or an external storage medium, for example, a removable disk including a universal serial bus (USB) memory, a storage connected to a host, a web server connected through a network or the like.

In addition, the memory 150 may store the reference temperature. Here, the reference temperature may be the temperature data at the time of factory calibration.

In addition, the memory 150 may store various correction tables. In the correction table, the initial calibration correction coefficient may be previously set to correspond to a light emission characteristic of a light emitting element. Therefore, in case of calculating the corrected transmitted light amount, the processor 130 may calculate the corrected transmitted light amount using the calibration correction coefficient stored in the memory 150 and the compensation coefficient based on the temperature difference.

The display 160 may display various data provided by the image forming device 100. For example, the display 160 may display a user interface window for the user to select various functions provided by the image forming device 100. The display 160 may be a monitor such as a liquid crystal display (LCD), a cathode ray tube (CRT), organic light emitting diodes (OLED) or the like, and may be implemented as a touch screen which may also perform below-described functions of the operation input device 170.

In addition, the display 160 may display a control menu for controlling the image forming device 100 to perform its functions.

The operation input device 170 may receive a function selected from the user and a corresponding function control instruction. Here, the functions may include printing, copying, scanning and faxing. The function control instruction may be input through the control menu displayed on the display 160.

The operation input device 170 may receive environment data of the image forming device 100. Here, the environment data may be data on its installation location such as whether its installation environment is a family house or a factory, and also temperature data on its installation environment.

The operation input device 170 may be implemented as a plurality of buttons, a keyboard, a mouse or the like, or may be implemented as the touch screen which may also perform the above-described functions of the display 160.

The temperature sensor 180 may measure the outside temperature. The temperature sensor 180 may be installed adjacent to the media sensor. The temperature sensor 180 may be installed inside or outside the image forming device 100.

As described above, the image forming device 100 according to an example may more accurately detect the thickness of the print paper even using the low-cost optical media sensor.

FIG. 3 is a diagram showing an example of a configuration of the print engine of FIG. 1.

Referring to FIG. 3, the print engine 110 may include a photosensitive drum 111, a charger 112, an exposure device 113, a developing device 114 a transfer device 115, a paper transport device 116 and a fusert 18.

Hereinafter, for convenience of explanation, the description describes, for example, components of the print engine 110 corresponding to one color. However, the print engine 110 may be implemented to include a plurality of photosensitive drums 111, a plurality of chargers 112, a plurality of exposure devices 200 and a plurality of developing devices 114, which correspond to a plurality of colors.

An electrostatic latent image may be formed on the photosensitive drum 111. The photosensitive drum 111 may be referred to as a photosensitive drum, a photosensitive belt or the like, depending on its form.

The charger 112 may charge a surface of the photosensitive drum 111 with a uniform potential. The charger 112 may be implemented in a form such as a corona charger, a charging roller, a charging brush or the like.

The exposure device 113 may form the electrostatic latent image on the surface of the photosensitive drum 111 by changing surface potential of the photosensitive drum 111 on a basis of data on image to be printed. For example, the exposure device 113 may form the electrostatic latent image by irradiating modulated light to the photosensitive drum 111 on the basis of data on image to be printed.

The developing device 114 may accommodate a developer, and supply the developer to the electrostatic latent image to develop the electrostatic latent image into a visible image. The developing device 114 may include a developing roller 117 supplying the developer to the electrostatic latent image. For example, the developer may be supplied from the developing roller 117 to the electrostatic latent image formed on the photosensitive drum 111 by a developing electric field formed between the developing roller 117 and the photosensitive drum 111.

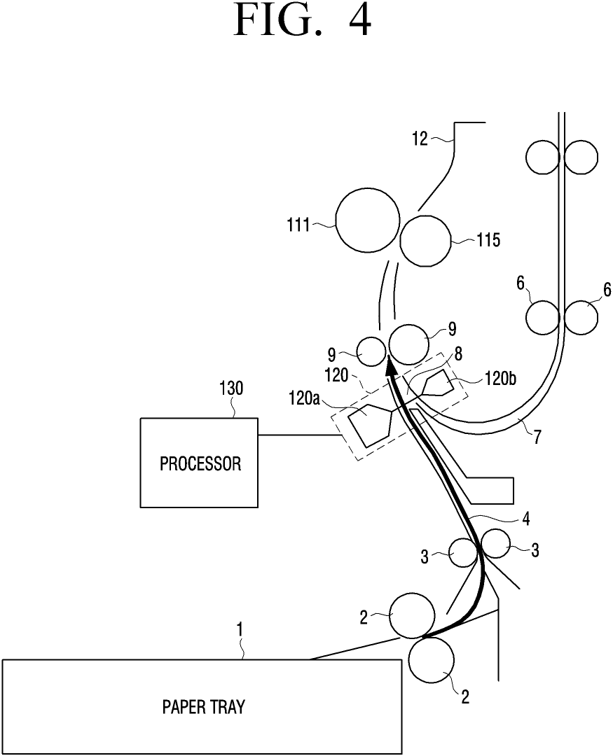

The paper transport device 116 may pick up a print paper P from the paper tray and transport the print paper P to a discharge tray. The below description describes an example of a configuration and operation of the paper transport device 116 with reference to FIG. 4.

The visible image formed on the photosensitive drum 111 may be transferred to the print paper by the transfer device 115. Meanwhile, FIG. 3 shows and describes a direct transfer method in which the image is formed directly on the print paper using the transfer device 115. However, the print engine may be implemented to adopt an indirect transfer method using an intermediate transfer belt.

The fuser 118 may apply heat and/or pressure to the visible image on the print paper P to fuse the visible image onto the print paper P. The print job may be completed by a series of processes as described above.

FIG. 4 is a schematic configuration diagram for describing an example of an installation form of the paper detection sensor of FIG. 1.

Referring to FIG. 4, the paper transport device may transport the print paper on a transport path, for example a paper transport path, using a plurality of rollers 2, 3, 6, 9 and the like.

A tray 1, for example a paper tray, may accommodate the print paper (a medium forming a toner image on its surface). FIG. 4 illustrates one paper tray, however, the image forming device may be implemented to include a plurality of paper trays.

The pickup roller 2 may pick up the print paper stored in the paper tray 1. The feed roller 3 may then feed the print paper picked up by the pickup roller 2 to a paper transport path 4.

The paper detection sensor 120 may be installed between the paper tray 1 and the registration roller 9. The paper detection sensor 120 may include optical sensors 120a and 120b referred to as optical media sensors.

The paper detection sensor 120 may detect the thickness of the print paper transported on the paper transport path 4. The paper detection sensor 120 may perform an operation to detect the thickness of the paper as described above in a process of transporting the print paper. Due to this operation, no extra time is required for a separate paper detection, which enables a faster print job. The below description describes an example of a configuration and operation of the optical sensor with reference to FIG. 5.

The inverted paper return path roller 6 may transport the print paper having printed one side along a return path 7 in case of performing a double-sided printing.

The paper transport path 4 and the return path 7 may join at a junction 8, and the print paper transported by the feed roller 3 and the print paper returned by the inverted paper return path roller 6 may pass through the junction 8. Meanwhile, in case of supporting a single-sided printing, the image forming device 100 may omit the above-described inverted paper return path roller 6 and return path 7.

The registration roller 9 may supply the print paper past through the junction 8 to the transfer device 115 under the control of the processor 130. This registration roller 9 may serve to align a skew of the transported paper.

An image forming carrier 12 may discharge the print paper having the printed one side to the outside, or may provide the print paper having the printed one side to the return path 7 in the case of the double-sided printing.

The processor 130 may parse the received print data to generate binary data, and may perform the print job using the generated binary data in case of receiving the print data.

In addition, the processor 130 may control the pickup roller 2 to pick up the print paper. By such an operation, the print paper may be picked up and enter the paper transport path by the feed roller 3.

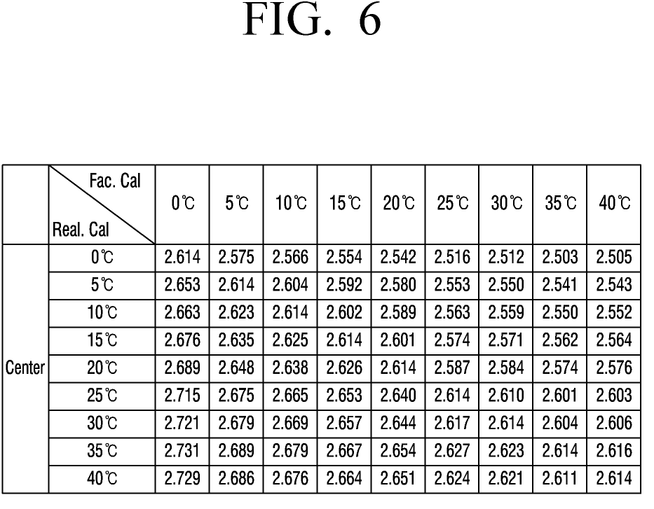

Here, the processor 130 may perform various programs to obtain a voltage value output from each light receiving sensor configuring the paper detection sensor 120, and may determine the type of the print paper being transported based on the obtained voltage value. An example of a determining operation of the processor 130 is described below with reference to FIG. 6.

After determining the type of the print paper, the processor 130 may select a proper printing condition such as a return speed, the transfer condition, the fusing condition and the like, of the print paper. After completing a preparation for the print job based on the corresponding conditions, the processor 130 may allow the print paper to pass through the transfer device 115 using the registration roller 9.

Meanwhile, the paper detection sensor 120 of FIG. 4 may be used for determining the type of the paper including the thickness and the like, and may also be used as a registration sensor. Here, the registration sensor may be used to detect an entry of the paper for a registration job.

Therefore, in case that the paper detection sensor 120 is used as the registration sensor, the processor 130 may determine whether the print paper is detected by the paper detection sensor using the transmitted light amount detected by the paper detection sensor 120, and may control the transport of the print paper based on whether the print paper is detected by the paper detection sensor 120.

Meanwhile, the processor 130 may be implemented as follows: the processor 130 may control the paper detection sensor 120 to perform both the above-described functions at the time at which there is the need to detect the thickness of the paper, i.e. at a first page of the print job; and may then control the paper detection sensor 120 to perform only the function of the registration sensor from a second page onwards.

As such, the paper detection sensor 120 may be implemented to perform the plurality of functions such as determining the type of the print paper and performing the registration job, thereby reducing manufacturing costs.

FIG. 5 is a conceptual diagram showing an operation example of the paper detection sensor.

The paper detection sensor 120 may include a light emitting element 121 and a plurality of light receiving sensors 123, 125 and 127.

The light emitting element 121 may be an optical component such as a light emitting diode (LED) that emits light The light emitting element 121 may be configured by the light emitting element itself, or may be configured of a plurality of optical components.

The transmitted light receiving sensor 123 may be installed almost in line with a path of light emitted from the light emitting element 121, and may detect the amount of light transmitted through the print paper among the light emitted from the light emitting element 121.

The specularly reflected light receiving sensor 125 may be installed at a position capable of detecting an amount of light specularly reflected from the print paper among the light emitted from the light emitting element 121.

The diffusely reflected light receiving sensor 127 may be installed at a position capable of detecting an amount of light diffusely reflected from the print paper among the light emitted from the light emitting element 121.

The transmitted light receiving sensor 123, the specularly reflected light receiving sensor 125 and the diffusely reflected light receiving sensor 127 may use, for example, a photodiode (PD) or phototransistor (PTr).

In addition, the above-described transmitted light amount, the specular light amount and diffusely reflected light amount may each be treated as a voltage value output by each light receiving sensor.

As described above, the paper detection sensor 120 may include the transmitted light receiving sensor 123, the specularly reflected light receiving sensor 125, and the diffusely reflected light receiving sensor 127. Therefore, the type of the paper may be determined by considering not only the transmitted light amount detected by the transmitted light receiving sensor 123, but also the specular light amount detected by the specularly reflected light receiving sensor 125 and the diffusely reflected light amount detected by the diffusely reflected light receiving sensor 127.

For example, the processor 130 may determine the thickness (or basis weight) of the paper using the transmitted light amount detected by the transmitted light receiving sensor 123; distinguish the characteristics of the paper, for example, whether the paper is high glossy or plain using the light amount detected by the specularly reflected light receiving sensor 125 and/or the diffusely reflected light receiving sensor 127; and determine the type of the paper by comprehensively considering the thickness and characteristics.

Meanwhile, in the above description, the processor uses only the transmitted light amount to determine the thickness of the paper. However, the processor may be implemented to determine the thickness with reference to the reflected light amount. In addition, the paper detection sensor 120 may be implemented to have only the above-described light emitting element 121 and the transmitted light receiving sensor 123.

Meanwhile, the output value in the optical media device may be affected by element characteristics of the light emitting diode (LED) which is the light emitting element and a photo transistor which is the light receiving sensor. Therefore, the factory calibration may be performed in a manufacturing process to correct the value and the factory calibration value may be stored in the memory 150.

In addition, the processor 130 may detect the thickness of the paper using the factory calibration value stored in the memory 150.

However, the above-mentioned elements may be affected by an ambient temperature during the operation, and the environment of a manufacturing factory may change due to the season. In addition, the user’s operating environment may be different from that of the manufacturing factory, and therefore the calibration value generated at a specific temperature is difficult to be used in various temperature environments.

For example, in case that a printer manufactured in a low temperature condition is used in a high temperature environment, or a printer manufactured in a high temperature condition is used in a low temperature condition, the thickness detection sensor may have constant detection offset and wide distribution of analog detection voltage.

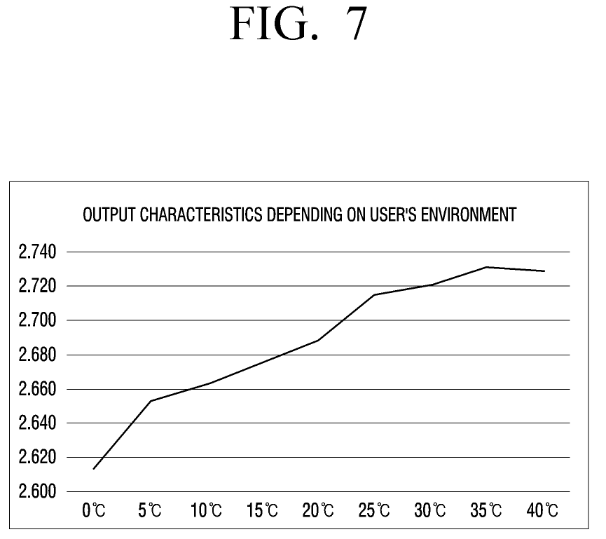

Such a phenomenon is described below with reference to FIGS. 6 and 7.

FIG. 6 is a diagram showing examples of detected values depending on various manufacturing environments and operating environments; and FIG. 7 is a graph showing examples of measured values depending on user temperature environments.

FIG. 6 shows examples of the detected values of analog-to-digital converter (ADC) for the same paper based on the difference between the temperature at which the factory calibration is performed and the temperature at which the printer is actually operated. The print paper having the same thickness may be detected to show different values depending on the ambient temperature or the factory temperature. Depending on the ambient environment, a thick print paper may be detected to be thin, and on the contrary, a thin print paper may be detected to be thick.

In particular, in case that the thick print paper is detected to be thin, insufficient transfer voltage and low temperature fusing may be applied to the thick paper in a printing process, thereby causing a malignant jam or an image defect.

FIG. 7 shows that the print paper having the same thickness or the same basis weight is measured to have a higher voltage value at higher outside temperature. Alternatively, even though the user’s operating environment is the same, if the temperature condition of the factory is different, the higher the temperature of the factory, the lower the voltage value of the print paper measured by the sensor.

As such, the difference between the temperature at which the factory calibration is performed and the temperature at which the printer is actually operated may cause the difference in the detected values of the ADC for the same paper. The image forming device of the disclosure may perform a temperature compensation operation to compensate for the difference in the output value due to the temperature difference described above.

The reference temperature may refer to a stored temperature read by temperature sensor mounted for performing the factory calibration after finishing a printer manufacturing process; and the outside temperature may refer to a temperature environment at the time at which the print instruction is input. Here, the difference between the two temperature values may be calculated.

Then, the difference value may be multiplied by the correction coefficient and the value may be applied to the measured voltage value to correct the detected value. This operation may be expressed as a following equation:

$$\begin{matrix}\text{SensingValue} \text{=} \\ \text{ADC} \left(\text{1+Compensation} \text{Constant K} \left(\text{Factory}\right.\right. \\ \left.\text{Temperature-Customer Temperature}\right) \left.\text{/5}\right)\end{matrix}$$

Here, SensingValue may refer to data on a corrected light amount, ADC may refer to a digital value for the output signal from the media sensor, and Compensation Constant K may refer to a constant value, for example, 0.004. In addition, Factory Temperature may refer to the temperature at the time of the factory calibration (i.e. reference temperature), and Customer Temperature may refer to a current temperature, i.e. the temperature value or the estimated temperature value of the temperature sensor measuring the outside temperature.

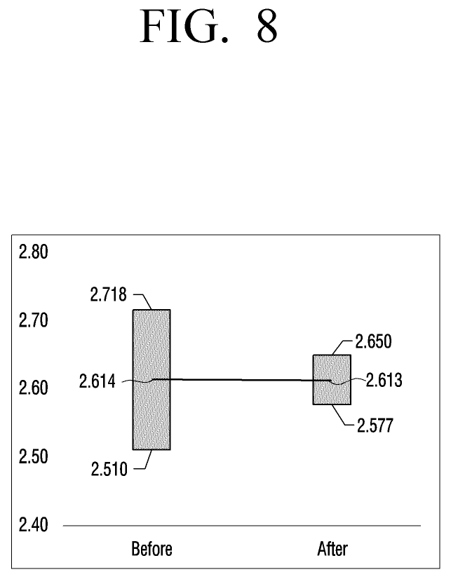

Accuracy of the media sensor may be improved by compensating for the output value of the media sensor in this way. Such an effect is described below with reference to FIG. 8.

FIG. 8 is a diagram showing examples of distributions of detected voltages before and after temperature compensation.

Referring to FIG. 8, before the temperature compensation, the detected value measured by the media sensor for the same thickness may range from at least 108 mV to at most 115 mV, depending on the ambient temperature.

In case that the temperature compensation is performed as described above, the detected value of the sensor may have a difference ranging from at least 26 mV to at most 28 mV. That is, occurrence of the distribution in the sensor may be reduced by about 75% by performing the temperature compensation. In particular, a standard deviation may also be improved by about 65% from 0.052 to 0.018.

In this way, the print paper may be identified more accurately using the optical media sensor. Therefore, there is no need to use expensive components such as ultrasonic or mechanical media sensors, thereby reducing the manufacturing costs. In addition, accurate thickness detection is possible, thereby reducing product liability (PL) risk for component damage due to a serious defect caused by false detection.

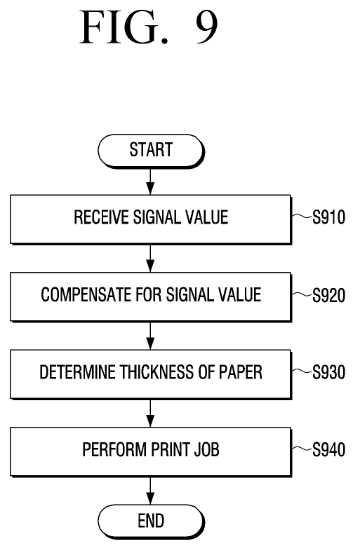

FIG. 9 is a flowchart showing a paper detection method according to an example.

Referring to FIG. 9, a signal value corresponding to an amount of light transmitted through a print paper may be received (S910). For example, a voltage value output from a paper detection sensor may be received.

In addition, data corresponding to the received signal value may be compensated for using temperature data (S920). For example, a compensation coefficient may be calculated using a difference value between a reference temperature and an outside temperature of the image forming device; and a corrected transmitted light amount may be calculated by applying the calculated compensation coefficient to the received data.

Then, a thickness of the print paper may be determined using the compensated value (S930). For example, a type of the print paper may be determined based on paper type data corresponding to each thickness range, and the determined thickness.

Then, an image may be formed on the print paper based on the determined thickness (S940). For example, a print job may be performed by adjusting a printing speed, a fusing state and a developing state based on the determined thickness of the print paper.

Therefore, according to the image forming method in an example, the thickness of the print paper may be detected more accurately even using the low-cost optical media sensor.

In addition, the image forming method as described above may be implemented by at least one execution program for executing the image forming method as described above, and such an execution program may be stored and provided in a non-transitory computer readable medium.

Although the examples are illustrated and described in the disclosure as above, the disclosure is not limited to the above mentioned examples, and may be variously modified by those skilled in the art to which the disclosure pertains without departing from the gist in the disclosure as disclosed in the accompanying claims. These modifications also need to be understood to fall within the scope and spirit in the disclosure.

What is claimed is:

1. An image forming device comprising:
a print engine to form an image on a medium;
a sensor to irradiate light onto the medium and to detect an amount of light transmitted through the medium; and
a processor to control the print engine based on the detected transmitted light amount and temperature data.

2. The image forming device as claimed in claim 1, wherein the processor to control the print engine based on the detected transmitted light amount and temperature data comprising the processor to compensate for the detected transmitted light amount using the temperature data, to determine a thickness of the medium using the compensated value, and to control the print engine based on the determined thickness.

3. The image forming device as claimed in claim 2, wherein the processor:
to calculate a compensation coefficient using a difference value between a reference temperature and an outside temperature of the image forming device;
to calculate a corrected transmitted light amount by applying the calculated compensation coefficient to the detected transmitted light amount; and
to determine the thickness of the medium using the calculated corrected transmitted light amount.

4. The image forming device as claimed in claim 3, comprising a memory to store an initial calibration correction coefficient corresponding to a light emission characteristic of a light emitting element emitting light onto the medium,
wherein the processor to calculate the corrected transmitted light amount based on the calculated compensation coefficient and the initial calibration correction coefficient.

5. The image forming device as claimed in claim 2, wherein the processor to determine a type of the medium based on paper type data corresponding to each thickness range, and the determined thickness.

6. The image forming device as claimed in claim 2,
wherein the sensor to detect an amount of light reflected from the medium at each of a plurality of positions, and
the processor to determine the type of the medium based on the transmitted light amount and the plurality of reflected light amount.

7. The image forming device as claimed in claim 6, wherein the sensor includes:
a light emitting element to emit light in a predetermined direction;
a first light receiving sensor to detect the amount of light transmitted through the medium among the light emitted from the light emitting element;
a second light receiving sensor to detect an amount of light specularly reflected from the medium among the light emitted from the light emitting element; and
a third light receiving sensor to detect an amount of light diffusely reflected from the medium among the light emitted from the light emitting element.

8. The image forming device as claimed in claim 2, comprising a temperature sensor to measure the outside temperature of the image forming device,
wherein the processor to compensate for data on the detected light amount using the outside temperature measured by the temperature sensor.

9. The image forming device as claimed in claim 2, wherein the processor to estimate the outside temperature of the image forming device and to compensate for the data on the detected light amount using the estimated outside temperature.

10. The image forming device as claimed in claim 2, wherein the processor to control transport of the medium based on whether the medium is detected by the sensor.

11. The image forming device as claimed in claim 1, wherein the sensor is included in a transport path between a tray and a registration roller.

12. A method of an image forming device comprising:
receiving a signal value corresponding to an amount of light transmitted through a medium; and
controlling the image forming device to form an image on the medium based on the signal value corresponding to the amount of light transmitted through the medium and on temperature data.

13. The method as claimed in claim 12, wherein the controlling the image forming device comprising:
compensating for data corresponding to the received signal value using the temperature data,
determining a thickness of the medium using the compensated value,
forming the image on the medium based on the determined thickness.

14. The method as claimed in claim 13, wherein the compensating includes:
calculating a compensation coefficient using a difference value between a reference temperature and an outside temperature of the image forming device;
calculating a corrected transmitted light amount by applying the calculated compensation coefficient to the data corresponding to the received signal value; and
determining the thickness of the medium using the calculated corrected transmitted light amount.

15. The method as claimed in claim 14, further comprising:
storing an initial calibration correction coefficient corresponding to a light emission characteristic of a light emitting element emitting light onto the medium, and
calculating the corrected transmitted light amount based on the calculated compensation coefficient and the initial calibration correction coefficient.
